(19) United States
(12) Patent Application Publication
(10) Pub. No.: US 2018/0041777 A1
(43) Pub. Date: Feb. 8, 2018

(54) Method and Apparatus for Encoding and Decoding Images

(71) Applicant: Nokia Technologies Oy, Espoo (FI)

(72) Inventor: Tero Rissa, Siivikkala (FI)

(21) Appl. No.: 15/554,120

(22) PCT Filed: Feb. 15, 2016
(86) PCT No.: PCT/FI2016/050093

§ 371 Date: Aug. 28, 2017

(30) Foreign Application Priority Data
Mar. 5, 2015 (GB) 1503689.0

(51) Int. Cl. H04N 19/64; H04N 19/436; H04N 19/93

(52) U.S. Cl. CPC H04N 19/647; H04N 19/93; H04N 19/436

(57) ABSTRACT

There are disclosed various methods and apparatuses for encoding an image. In some embodiments the method comprises obtaining a stripe comprising a magnitude bit of two or more coefficients, each magnitude bit belonging to the same bit-plane. The coefficients represent an image or a part of the image. The method further comprises obtaining significance state of said coefficients and significance state of coefficients neighboring said two or more coefficients on the current bit-plane; obtaining significance state of said coefficients and the significance state of coefficients neighboring the said two or more coefficients on one bit-plane above the current bit-plane; obtaining the significance state of said coefficients on two bit-planes above the current bit-plane; obtaining a significance propagation state context matrix comprising the significance propagation of said coefficients and significance state of coefficients neighboring the said two or more coefficients on the current bit-plane; and using at least one of said matrices to construct a context label for each said two or more magnitude bits in parallel by assigning a context label selected from a set of context labels.

### TECHNICAL FIELD

The present invention relates to image compression, more specifically to a method for coefficient bit modeling and an apparatus for coefficient bit modeling.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Joint Photographic Experts Group (JPEG) has published a standard for compressing image data known as the JPEG standard. The JPEG standard uses a discrete cosine transform (DCT) compression algorithm that uses Huffman encoding. To improve compression quality for a broader range of applications, the JPEG has developed the “JPEG 2000 standard” (International Telecommunications Union (ITU) Recommendation T.800, August 2002). The JPEG 2000 standard uses discrete wavelet transform (DWT) and adaptive binary arithmetic coding compression.

### SUMMARY

Various embodiments provide a method and apparatus for encoding images.

Various aspects of examples of the invention are provided in the detailed description.

According to a first aspect, there is provided a method comprising:

obtaining a stripe comprising a magnitude bit of two or more coefficients, each magnitude bit belonging to the same bit-plane, said coefficients representing an image or a part of the image;

obtaining a context matrix comprising significance state of said coefficients and significance state of coefficients neighboring said two or more coefficients on a current bit-plane;

obtaining a previous layer context matrix comprising the significance state of said coefficients and the significance state of coefficients neighboring said two or more coefficients on a previous bit-plane which is one layer above the current bit-plane;

obtaining a context stripe of a bit-plane which is one layer above the previous bit-plane comprising the significance state of said coefficients on a bit-plane which is two layers above the current bit-plane;

obtaining a significance propagation state context matrix comprising the significance propagation significance state of said coefficients and significance propagation significance state of coefficients neighboring the said two or more coefficients on the current bit-plane;

using at least one of said matrices and/or stripes to construct a context label for each said two or more magnitude bits in parallel by assigning a context label selected from a set of context labels.

According to a second aspect, there is provided an apparatus comprising:

means for obtaining a stripe comprising a magnitude bit of two or more coefficients, each magnitude bit belonging to the same bit-plane, said coefficients representing an image or a part of the image;

means for obtaining a context matrix comprising significance state of said coefficients and significance state of coefficients neighboring said two or more coefficients on a current bit-plane;

means for obtaining a previous layer context matrix comprising the significance state of said coefficients and the significance state of coefficients neighboring said two or more coefficients on a previous bit-plane which is one layer above the current bit-plane;

means for obtaining a context stripe of a bit-plane which is one layer above the previous bit-plane comprising the significance state of said coefficients on a bit-plane which is two layers above the current bit-plane;

means for obtaining a significance propagation state context matrix comprising the significance propagation significance state of said coefficients and significance propagation significance state of coefficients neighboring said two or more coefficients on the current bit-plane;

means for using at least one of said matrices and/or stripes to construct a context label for each said two or more magnitude bits in parallel by assigning a context label selected from a set of context labels.

### BRIEF DESCRIPTION OF THE DRAWINGS

For a more complete understanding of example embodiments of the present invention, reference is now made to the following descriptions taken in connection with the accompanying drawings in which:

FIG. 1a shows an image comprising one or more components in accordance to an example embodiment;

FIG. 1b shows an image component comprising a rectangular array of pixels, in accordance to an example embodiment;

FIG. 1c shows an image component divided into tiles, in accordance to an example embodiment;

FIG. 2 illustrates an example of an encoding apparatus and a decoding FIG. 2 illustrates an example of an encoding apparatus and a decoding apparatus, in accordance with an embodiment;

FIG. 3a illustrates computation of a forward transform to the tile-component data in an iterative manner, in accordance with an embodiment;

FIG. 3b illustrates the result of the computation of a forward transform to the tile-component data, in accordance with an embodiment;

FIG. 3c depicts an example of coefficients organized in sign and magnitude bit-planes;

FIG. 4 depicts as a flow diagram an example embodiment of the operation of the apparatus;

FIG. 5 illustrates an example of scanning order of samples of code-blocks, in accordance with an embodiment;

FIGS. 6a to 6c illustrate three possible masks used to select 8-connect neighbors of a sample, in accordance with an embodiment;

FIG. 7a shows a block diagram of an apparatus according to an example embodiment;

FIG. 7b shows an example of a context output for one bit of a stripe, in accordance with an embodiment;

FIG. 7c shows an example of a parallel context output for one stripe, in accordance with an embodiment;

FIG. 7d illustrates an example of a context matrix;

FIG. 7e illustrates an example of using some values of the context matrix of FIG. 7d in context modeling;

FIG. 7f illustrates an example of context matrices and stripes as output of a context matrix generator;

FIG. 8 depicts as a flow diagram an example embodiment of the construction of a significance propagation pass context matrix;

FIG. 9 shows a block diagram of an apparatus according to an example embodiment;

FIG. 10 shows an apparatus according to an example embodiment;

FIG. 11 shows an example of an arrangement for wireless communication comprising a plurality of apparatuses, networks and network elements.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

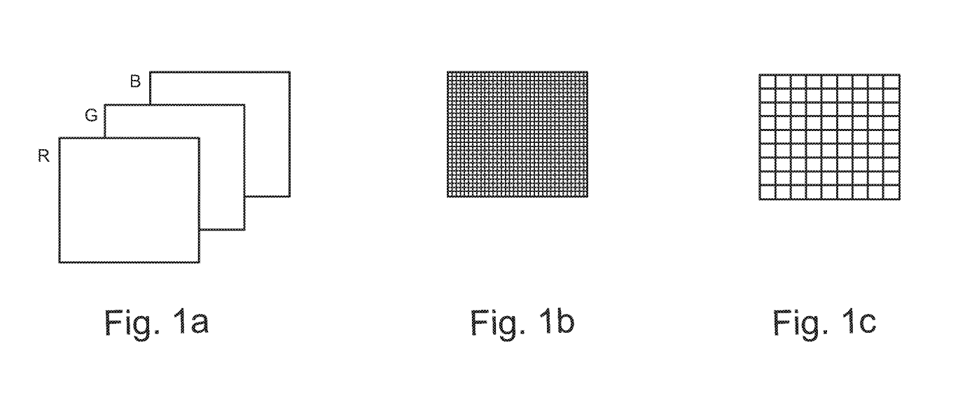

In the following some details of digital images are provided. An image may be comprised of one or more components, as shown in FIG. 1a. Each component may consist of a rectangular array of samples, as is illustrated in FIG. 1b. Sample values for each component may be integers and can either be signed or unsigned with a certain precision, such as from 1 to 38 bits/sample. The signedness and precision of the sample data may be specified on a per-component basis. All of the components are associated with the same spatial extent in the source image, but may represent different spectral or auxiliary information. For example, a RGB (Red-Green-Blue) color image has three components. One of the components represents red color plane, another component represents green color plane, and yet another component represents blue color plane. In a grayscale image there is only one component corresponding to the luminance plane. The various components of an image need not be sampled at the same resolution, wherein the components may have different sizes. For example, when color images are represented in a luminance-chrominance color space, the luminance information may be more finely sampled than the chrominance data.

In some situations, an image may be quite large in comparison to the amount of memory available to the codec. Consequently, it may not always be feasible to code the entire image as a single unit. Therefore, an image may be broken into smaller pieces, each of which may be independently coded. More specifically, an image may be partitioned into one or more disjoint rectangular regions called tiles. An example of such partitioning is depicted in FIG. 1c.

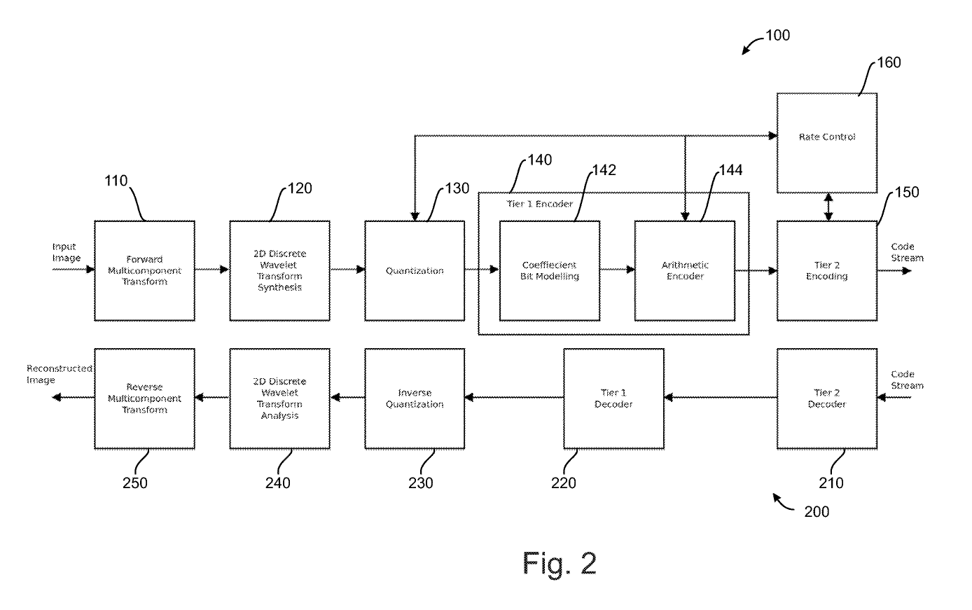

FIG. 2 depicts an example of an encoding apparatus 100 and an example of a decoding apparatus 200 as a simplified block diagrams. The encoder 100 may comprise the following elements: a forward multicomponent transform block 110, an intracomponent transform block 120, a quantization block 130, a tier-1 coding block 140, a tier-2 coding block 150, and a rate control block 160. The decoder structure essentially mirrors that of the encoder. Hence, there may be a one-to-one correspondence between functional blocks in the encoder and decoder. Thus, in accordance with an embodiment and as illustrated in FIG. 2, the following elements may be part of the image decoder 200: a tier-2 decoding block 210, a tier-2 decoding block 220, a dequantization block 230, an inverse intracomponent transform block 240, and a reverse multicomponent transform block 250. Each functional block in the decoder 200 may either exactly or approximately invert the effects of its corresponding block in the encoder 100.

Since tiles may be coded independently of one another, the input image may be processed one tile at a time.

In the following, the operation of each of the above blocks is explained in more detail.

The forward multicomponent transform block 110 may apply a multicomponent transform to the tile-component data. Such a transform may operate on all of the components together, and may serve to reduce the correlation between components, leading to improved coding efficiency.

The multicomponent transforms may be an irreversible color transform (ICT) or a reversible color transform (RCT). The irreversible color transform is nonreversible and real-to-real in nature, while the reversible color transform is reversible and integer-to-integer. Both of these transforms map image data from the RGB to YCrCb color space. The transforms may operate on the first three components of an image, with the assumption that components 0, 1, and 2 correspond to the red, green, and blue color planes. Due to the nature of these transforms, the components on which they operate are sampled at the same resolution. In other words, the components have the same size. After the multicomponent transform stage in the encoder 100, data from each component may be treated independently.

The intracomponent transform block 120 may operate on individual components.

An example of the intracomponent transform is the discrete wavelet transform (DWT), wherein the intracomponent transform block 120 may apply a two-dimensional discrete wavelet transform (2D DWT). Another example of intracomponent transform is the change from unsigned number representation to signed number representation, and further example is change to zero DC offset, where the median value is represented with number zero and smallest value with smallest negative number of the range and the largest value with the largest positive value of the range. The discrete wavelet transform splits a component into numerous frequency bands (i.e., subbands). Due to the statistical properties of these subband signals, the transformed data may be coded more efficiently than the original untransformed data. Both reversible integer-to-integer and nonreversible real-to-real discrete wavelet transforms may be employed by the encoder 100. The discrete wavelet transform may apply a number of filter banks to the pre-processed image samples and generate a set of wavelet coefficients for each tile.

Since an image is a two-dimensional (2D) signal, the discrete wavelet transform is applied in both the horizontal and vertical directions. The wavelet transform may then be calculated by recursively applying the two-dimensional discrete wavelet transform to the lowpass subband signal obtained at each level in the decomposition.

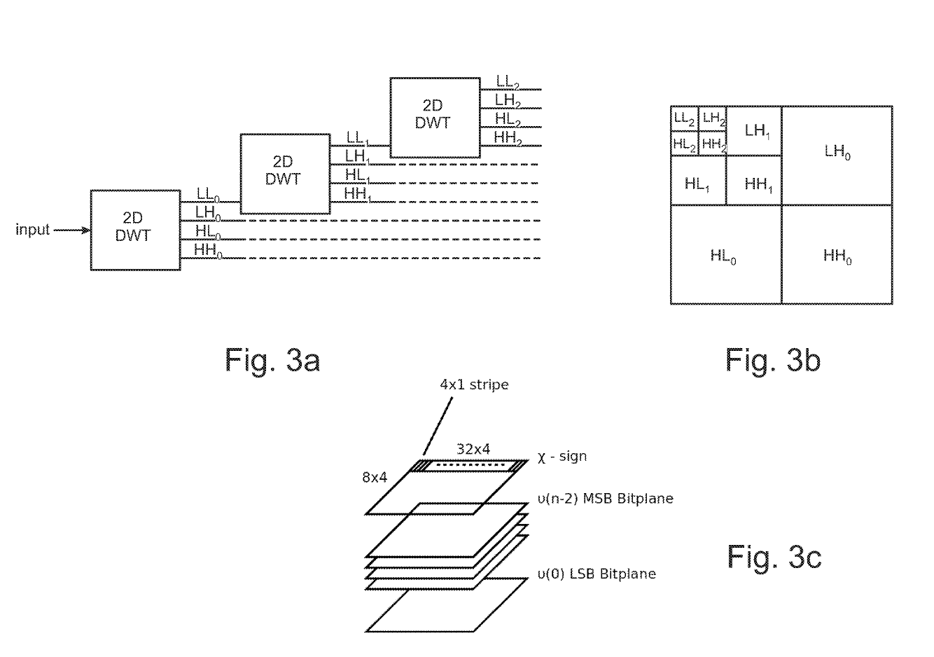

In the following, it is supposed that a (R-1)-level wavelet transform is to be employed. The forward transform may be computed to the tile-component data in an iterative manner, as is illustrated in FIG. 3a, wherein a number of subband signals are produced. Each application of the forward transform yields four subbands: 1) horizontally and vertically lowpass (LL), 2) horizontally lowpass and vertically highpass (LH), 3) horizontally highpass and vertically lowpass (HL), and 4) horizontally and vertically highpass (HH). A (R-1)-level wavelet decomposition is associated with R resolution levels, numbered from 0 to R-1, with 0 and R-1 corresponding to the finest and coarsest resolutions, respectively. Each subband of the decomposition may be identified by its orientation (e.g., LL, LH, HL, HH) and its corresponding resolution level (e.g., 0, 1, . . . , R-1). The input tile-component signal is considered to be the LL₀ band. At each resolution level (except the highest, R-1 level) the LL band may further be decomposed. For example, the LL₀ band is decomposed to yield the LL₁, LH₁, HL₁, and HH₁ bands. Then, at the next level, the LL₁ band is decomposed, and so on. This process may be repeated until the LL_{R-1} band is obtained, and results in the subband structure illustrated in FIG. 3b.

Transformed coefficients may be obtained by the two-dimensional discrete wavelet transform so that a number of coefficients are collected from each repetition as is depicted in FIG. 3a. From the first pass of the discrete wavelet transform coefficients from the horizontally and vertically highpass subband HH₀, coefficients from the horizontally highpass and vertically lowpass subband HL₀, and coefficients from the horizontally lowpass and vertically highpass subband LH₀ may be obtained to represent those subbands. Similarly, from the second pass of the discrete wavelet transform coefficients from the horizontally and vertically highpass subband HH₁, coefficients from the horizontally highpass and vertically lowpass subband HL₁, and coefficients from the horizontally lowpass and vertically highpass subband LH₁ may be obtained to represent the coefficients of those subbands. In the same way, coefficients of three subbands may be obtained from each pass. From the last pass of the discrete wavelet transform coefficients from each subband is obtained, i.e. the horizontally and vertically highpass subband HH₀, the horizontally highpass and vertically lowpass subband HL₀, the horizontally lowpass and vertically highpass subband LH₀, and the horizontally and vertically lowpass subband HH₀.

The bits of the coefficients may be arranged in different bit-planes e.g. as follows. Signs of the coefficients may form a sign layer, the most significant bits (MSB) of the coefficients may form a most significant bit-plane, or layer n-2, if n is the number of bits of the coefficients (including the sign), the next most significant bits of the coefficients may form a next bit-plane, or layer n-3, etc. The least significant bits (LSB) of the coefficients may form a least significant bit-plane, or layer 0. The bit-plane other than the sign layer may also be called as magnitude bit-planes υ(n-2), to υ(0). The sign bit-plane may be called χ. FIG. 3c depicts an example of coefficients organized in bit-planes.

The quantization block 130 quantizes the transformed coefficients obtained by the two-dimensional discrete wavelet transform. Quantization may allow greater compression to be achieved by representing transform coefficients with smaller precision but high enough required to obtain the desired level of image quality. Transform coefficients may be quantized using a scalar quantization. A different quantizer may be employed for the coefficients of each subband, and each quantizer may have only one parameter, a step size. Quantization of transform coefficients is one source of information loss in the coding path, wherein, in a lossless encoding, the quantization may not be performed. The quantized wavelet coefficients may then be arithmetic coded, for example. Each subband of coefficients may be encoded independently of the other subbands, and a block coding approach may be used.

The coefficients for each subband may be partitioned into code-blocks e.g. in the tier-1 coding block 140. Code-blocks are rectangular in shape, and their nominal size may be a free parameter of the coding process, subject to certain constraints. The nominal width and height of a code-block may be an integer power of two, and the product of the nominal width and height may not exceed a certain value, such as 4096. Since code-blocks are not permitted to cross precinct boundaries, a reduction in the nominal code-block size may be required if the precinct size is sufficiently small. The size of the code-blocks of different subbands may be the same or the size of the code-blocks may be different in different subbands.

The encoding of the code-blocks may also be referred to as coefficient bit modeling (CBM), that may be followed by arithmetic encoding. In context modeling, the coefficients in a code-block are processed bit-plane by bit-plane, starting from the bit-plane which has the coefficient with the most significant non-zero bit in the code-block. A context label is generated for each coefficient in the bit-plane in one of three passes: significance propagation pass (SPP), magnitude refinement pass (MRP), or clean up pass (CU), and each context label is used to describe the context (CX) of that coefficient in that bit-plane. In addition a decision bit (D) is given with each context. A coefficient can become significant in the significance propagation pass or the clean up pass, when the first non-zero magnitude bit is encountered. The significance state of a coefficient bit that has magnitude of 0 (the value of the bit is 0) can anyhow impact to the context of its neighbor coefficients.

After a subband has been partitioned into code-blocks, each of the code-blocks may be independently coded. For each code-block, an embedded code may be produced, comprised of numerous coding passes. The output of the tier-1 encoding process is, therefore, arithmetic encoding of a collection CX-D pairs (from which sign-context-decision pair (SCD-SD) is another example) of coding passes for the various code-blocks. In accordance with an embodiment, the coefficient bit modelling is performed using the parallel single-pass coefficient bit modelling unit described later in this specification.

In the tier-2 coding block 150 code-blocks are grouped into so called precincts. The input to the tier-2 encoding process is the set of bit-plane coding passes generated during tier-1 encoding. In tier-2 encoding, the coding pass information is packaged into data units called packets, in a process referred to as packetization. The resulting packets are then output to the final code stream. The packetization process imposes a particular organization on coding pass data in the output code stream. This organization facilitates many of the desired codec features including rate scalability and progressive recovery by fidelity or resolution.

A packet is a collection of coding pass data comprising e.g. two parts: a header and a body. The header indicates which coding passes are included in the packet, while the body contains the actual coding pass data itself In a coded bit stream, the header and body need not appear together but they may also be transmitted separately.

Each coding pass is associated with a particular component, resolution level, subband, and code-block. In tier-2 coding, one packet may be generated for each component, resolution level, layer, and precinct 4-tuple. A packet need not contain any coding pass data at all. That is, a packet can be empty. Empty packets may sometimes be needed since a packet should be generated for every component-resolution-layer precinct combination even if the resulting packet conveys no new information.

Since coding pass data from different precincts are coded in separate packets, using smaller precincts reduces the amount of data contained in each packet. If less data is contained in a packet, a bit error is likely to result in less information loss (since, to some extent, bit errors in one packet do not affect the decoding of other packets). Thus, using a smaller precinct size leads to improved error resilience, while coding efficiency may be degraded due to the increased overhead of having a larger number of packets.

The rate control block 160 may achieve rate scalability through layers. The coded data for each tile is organized into L layers, numbered from 0 to L-1, where L≧1. Each coding pass is either assigned to one of the L layers or discarded. The coding passes containing the most important data may be included in the lower layers, while the coding passes associated with finer details may be included in higher layers. During decoding, the reconstructed image quality may improve incrementally with each successive layer processed. In the case of lossy compression, some coding passes may be discarded, wherein the rate control block 160 may decide which passes to include in the final code stream. In the lossless case, all coding passes should be included. If multiple layers are employed (i.e., L>1), rate control block 160 may decide in which layer each coding pass is to be included. Since some coding passes may be discarded, tier-2 coding may be one source of information loss in the coding path. Rate control can also adjust the quantizer used in the quantization block 130.

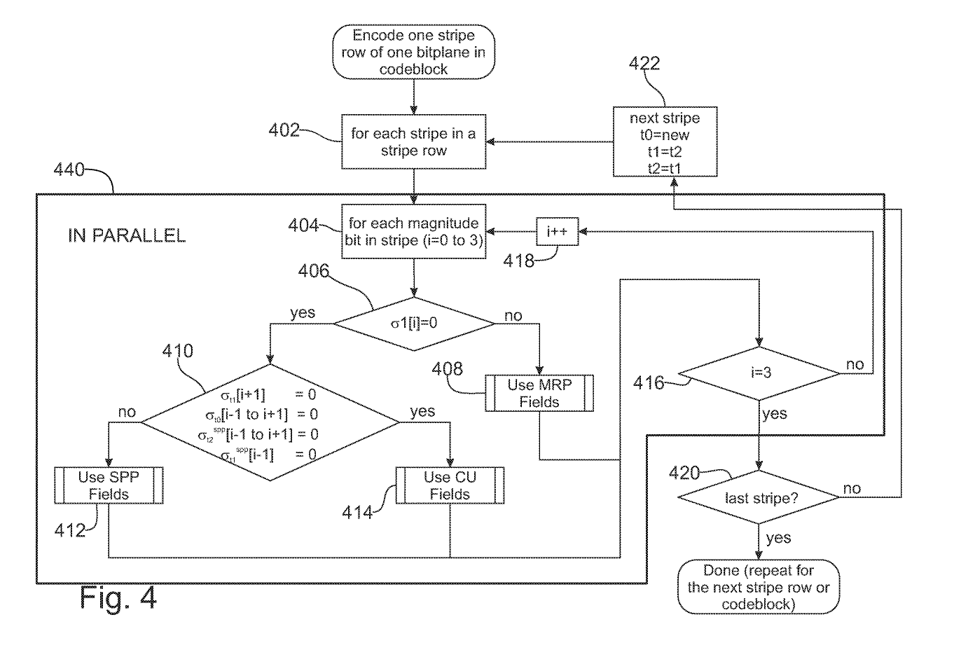

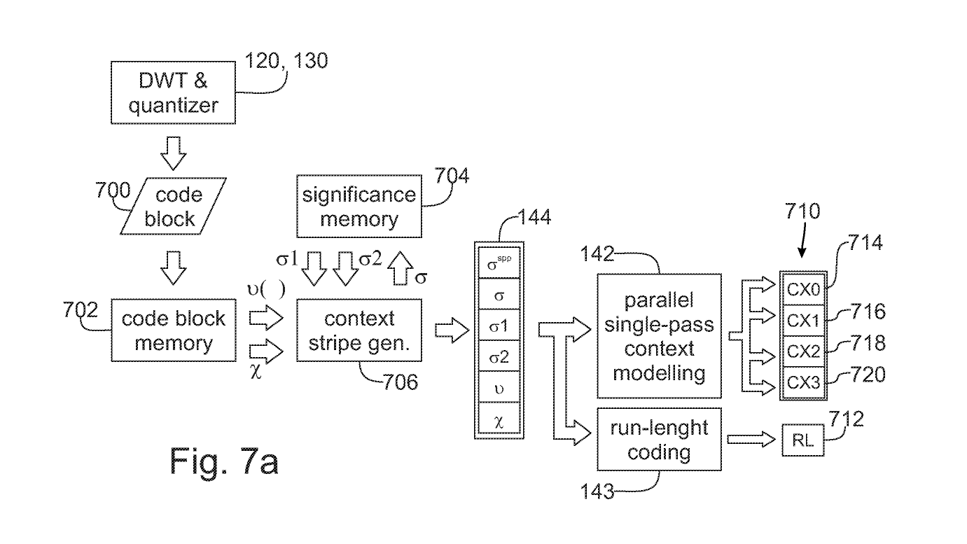

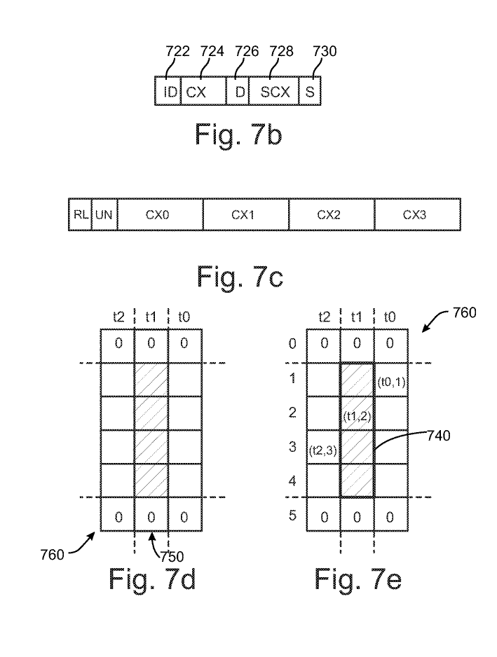

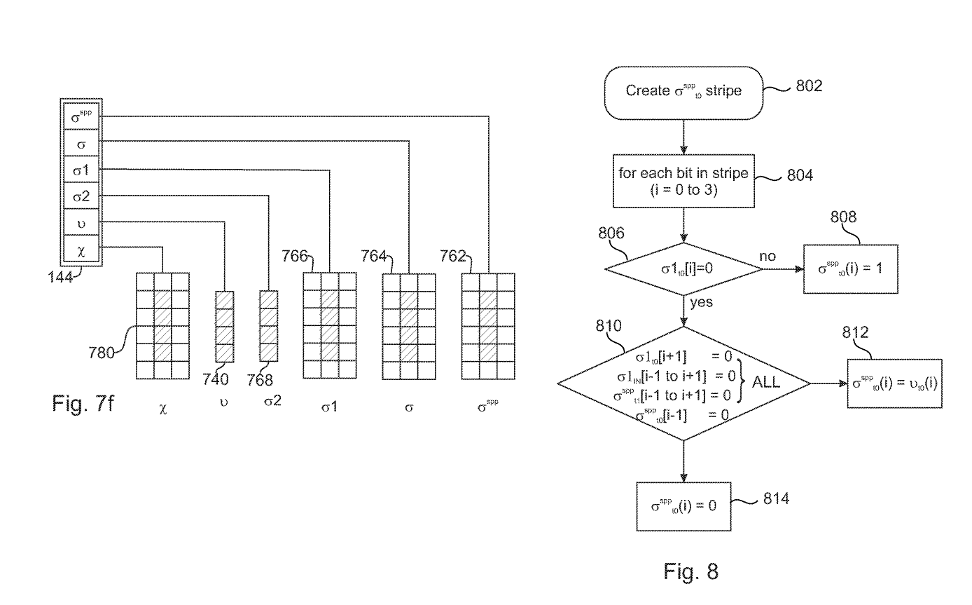

In the following, more detailed description of the parallel single-pass coefficient bit encoder of tier-1 encoding is provided with reference to the flow diagram of FIG. 4 and the apparatus of FIG. 7a, in accordance with an embodiment. On each bit-plane three different kinds of coding passes may be performed: a significance propagation pass (SPP), a magnitude refinement pass (MRP), and a cleanup pass (CU). All three types of coding passes may scan the samples of a code-block in the same fixed order. The code-blocks may be encoded in the order according to a vertical stripe scanning model. In addition, four coding primitives may be used: a run-length (RL) primitive, a zero coding (ZC) primitive, a magnitude refinement (MR) primitive, and a sign coding (SC) primitive.

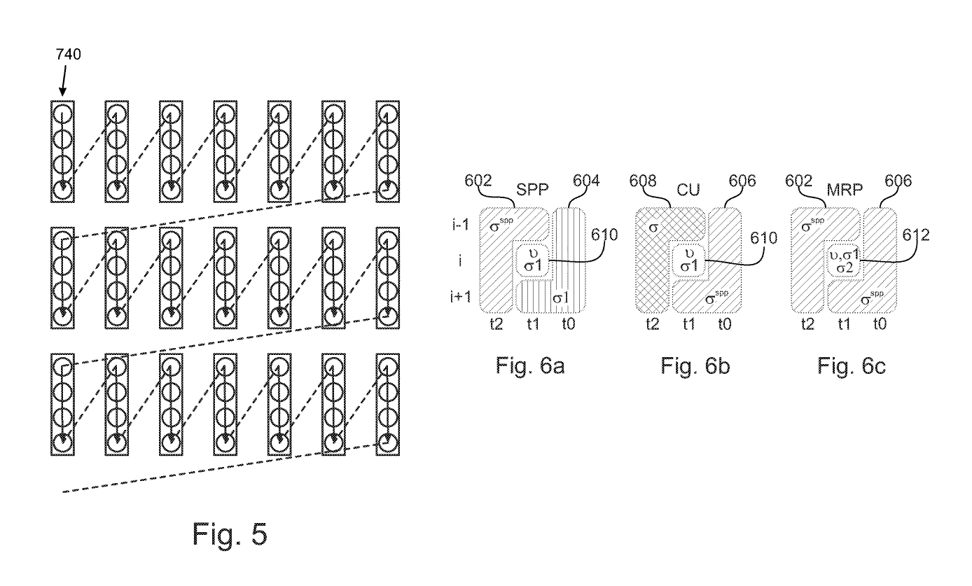

In the following, it is assumed that the size of the code-blocks is 32×32 bits and each DWT coefficient has 11 bits. However, the principles may be implemented with other code-block sizes, such as 64×64 bits, and coefficient sizes different from 11 bits. Furthermore, the code-block need not be square but may also be rectangular. According to the vertical stripe scanning model, samples of code-blocks are scanned in the order illustrated in FIG. 5, namely starting from the top of the left-most column (i.e. from the top-left corner of the code-block) and scanning the column four samples downwards, then moving to the next four-sample column to the right, scanning the column for the four samples, etc. When the samples of the last, right-most column have been scanned, the process continues from the next four samples of the second column. These four samples of a column can be called as a stripe and a term stripe row may be used for the column, i.e. a collection of stripes in the same rows in each column of the code-block. For example, samples on the first four rows form the first stripe row, samples on the rows five to eight form the second stripe row, etc. When the last stripe row is scanned, the next coding pass is started from the same magnitude layer, unless it is clean up pass, then next magnitude layer is processed, unless it's the layer 0, i.e. the least significant bit-plane, then next code-block is processed, if needed.

For each coefficient of each bit-plane of the code-block may be assigned a variable called significance state. The significance state value may be, for example, 1, if the sample is significant and 0, if the sample is not significant (i.e. insignificant). In the beginning of the encoding of a bit-plane the significance state of each sample may be assigned a default value “not significant”. The significance state may then toggle to significant during propagation of the encoding process.

The magnitude bit-planes of the code-block may be examined, beginning e.g. from the most significant magnitude bit-plane in which at least one bit is non-zero (i.e. is one). This bit-plane may be called as a most significant non-zero bit-plane. Then, the scanning of samples of the code-block may be started from the most significant non-zero bit-plane using the vertical stripe scanning model.

Transformed and quantized coefficients 700 of code-blocks or parts of them may have been stored into a code-block memory 702. In accordance with an embodiment, there may be a significance memory 704 from which two past significance states (σ1 and σ2) of coefficients of a stripe in bit-planes one and two layer higher, respectively, can be read.

A context generator block 706 may operate as follows. The context generator block 706 reads significance states 61 and 62 and the magnitude stripe u and sign stripe χ of the next stripe in processing order. From these, the magnitude u and significance 62 are passed directly to the parallel single-pass context modelling and run-length coding blocks. For the others context matrices as illustrated in FIGS. 7d, 7e and 7f are formed: Final context matrix σ (sigma), which signifies the final significance states of the coefficient bits of a bit-plane; a significance propagation pass context matrix σ^{SPP} signifying significance states as they would be after significance propagation pass; previous context matrix σ1 signifying final significance states of a previous bit-level: and sign context matrix x signifying the sign context.

The context matrices contain two dimensions, one in time t and one in bit order i. In order to facilitate efficient computing of parallel single-pass coefficient bit modelling, the context matrices can be extended outside the stripe region with topmost and bottom level containing always value zero. When the context matrix generator creates a new set of significance bits, they become the values on column t0. In the beginning of each processing step, values of t0 becomes t1 and values of t1 becomes t2. For the processing, the current stripe is located in time t1, and this is where the magnitude u and significance σ2 stripes are also aligned.

The significance state of a coefficient of a stripe σ^{SPP}ₜ₀ of the significance propagation pass context matrix SPP may be obtained 802 e.g. as follows. This is illustrated in FIG. 8 as a flow diagram in accordance with an embodiment. For each bit in the stripe (804) the following operations may be performed e.g. in parallel. If the significance state of the current coefficient on a previous layer σ1ₜ₀[i] was significant (block 806), the significance state remains as significant (σ^{SPP}ₜ₀(i)=1, block 808). If the significance state of the current coefficient was insignificant on a previous layer the significance state values of neighboring coefficients may be examined 810, for example, as follows. The significance state of coefficients “in the past” i.e. the significance state of coefficients already processed on the current bit-plane is determined on the basis of significance state values of neighboring coefficients in the significance propagation pass context matrix SPP In other words, those coefficients are in the column on the left side of the current stripe (t2 in FIG. 6a) and the coefficient on the previous row i−1 and the same column t1 (σ^{SPP}ₜ₁[i−1 to i+1]=0 and σ^{SPP}ₜ₀[i−1]=0). Further, the significance state of coefficients which have not been processed on the current bit-plane (i.e. the significance state is “in the future”) is determined on the basis of significance state of neighboring coefficients in the previous context matrix σ1. In other words, those coefficients are in the column on the right side of the current stripe (t0 in FIG. 6a) and the coefficient on the next row i+1 and the same column t1 (σl_{IN}[i−1 to i+1]=0 and σ1ₜ₀[i+1]=0). If any of these significance values is significant, the significance value of the current coefficient of the stripe σ^{SPP}ₜ₀ of gets the value of the magnitude bit of the coefficient on the current bit-plane (σ^{SPP}ₜ₀(i)=υ(t), block 812). Otherwise, the significance value of the current coefficient of the stripe σ^{SPP}ₜ₀ remains insignificant (σ^{SPP}ₜ₀(i)=0, block 814).

Next, some of the markings used in FIGS. 4, 6a to 6c, 7d to 7f are briefly explained. The notations i and t1 mean the current sample location, notations i+1 and i−1 mean neighboring context matrix locations on the next row and on a previous row, respectively, and notations t0, t1 and t2 mean neighboring context matrix locations on the next column and on a previous column, respectively. FIGS. 6a to 6c illustrate masks used to select which bit location of which context matrix is selected for each 8-connected neighbor on different processing steps.

The elements of the final context matrix σ corresponding the stripe where the current sample location belongs to may be indicated as σ[i], 0≦i<4, or σₜ₁[i], 0≦i<4. Correspondingly, the elements of the final context matrix σ corresponding the stripe to the left of the current sample location may be indicated as σₜ₂[i], 0≦i<4, and the elements of the final context matrix σ corresponding the stripe to the right of the current sample location may be indicated as σₜ₀[i], 0≦i<4. Similar notations may be used with the other matrices as well (σ1ₜ₂[i], σ1ₜ₁[i], σ1ₜ₀[i]; σ^{SPP}ₜ₂[i], σ^{SPP}ₜ₁[i], σ^{SPP}ₜ₀[i]; χₜ₂[i], χₜ₁[i], χₜ₀[i]). In accordance with an embodiment, the size (height) of the stripe is 4 bits, wherein the size of the context matrix can be 6 bits high and 3 bits wide. However, the stripe and context matrix may also have other sizes, such as 2 bits and 4×3 bits; 8 bits and 10×3 bits; etc. The width of the stripe may also be other than one bit, e.g. two bits, wherein the context matrix may then also be wider than the above examples.

In the beginning of processing a code-block, the context generator block 706 may initialize all context matrices σ^{SPP}, σ, σ1, and χ and context memory of σ1 and σ2, so that each element of the matrices indicates an insignificant state (e.g. the elements are set to 0). Also, in the beginning of processing a stripe row, the context generator block 706 may initialize context matrices σ^{SPP}, σ1, and χ, so that when the current stripe is being processed in t1, the t2 values are all insignificant.

The context generator block 706 may construct and output to the parallel single-pass context modeling block 142 and to the run-length encoder 143 e.g. the following information regarding the current stripe 144 as illustrated in FIG. 7f: a context matrix 762 of the significance propagation pass matrix SPP a context matrix 764 of the final context matrix σ, a context matrix 766 of the previous context matrix σ1, a context matrix 768 of the second-most previous context stripe 62, a magnitude stripe 740 of the magnitude bits of the current stripe υ, and a context matrix 780 of the sign context matrix χ. From this information output by the context generator block 706 significance masks may be used to select the correct values to use. This information may be, for example, 6 bits high as the middle column 750 in

FIG. 7d illustrates, so when moving along the current column t1 from up to down (i.e. i=0, . . . , 3), each significance mask can have a valid value.

The above mentioned data is input to the parallel single-pass context modeling block 142 for bit-plane encoding. Together with context matrix generator, this block performs the processing depicted in FIG. 4, more specifically parallel single-pass block processes the section 440. For each magnitude bit in the stripe (404, 740) it is examined 406 whether the significance state at the current coefficient location at one bit-plane which is one layer higher is significant or not by examining the value of the previous context matrix σ1 at the same location i than the current sample, i.e. σ1[i]. If the significance state of the sample location has been found significant on a bit-plane which is at a more significant (higher) layer (i.e. σ1[i]=1), MRP significance mask depicted in FIG. 6c may be utilized for context modelling for that sample location (408). If the significance state of the sample location is not significant at bit-plane which is one layer higher, a further examination may be performed 410 utilizing significance state information of the neighboring samples which may predict whether the sample would have significant neighbors in SPP. The neighboring samples may be the eight neighbor samples (8-connect neighbors) around the current sample, but the examined significance states may not represent bits on the same bit-plane than the current bit. In this examination values from the previous context matrix σ1 and the significance propagation pass context matrix σ^{SPP} may be used e.g. as follows.

The significance state of the bit in the same column but in the next row of the bit-plane which is one layer above of the current bit-plane may be examined, i.e. the value of the previous context matrix σlₜ₁[i+1]. If the significance state is significant (i.e. σ1ₜ₁[i+1]≠0), significance propagation pass masks may be used 412 in encoding the context and decision pairs for this magnitude bit. This condition is illustrated in the first row in the block 410 of the flow diagram of FIG. 4.

Further, the significance state of bits in the next column t0 of the bit-plane which is one layer above of the current bit-plane may be examined, i.e. the values of the previous context matrix σ1ₜ₀[i−1], σ1ₜ₀[i] and σ1ₜ₀[i+1]. If the significance state is significant (i.e. σ1ₜ₀[i−1]≠0 or a σ1ₜ₀[i]≠0 or σ1ₜ₀[i+1]≠0), significance propagation pass masks may be used 412 in encoding the context and decision pairs for this magnitude bit. This condition is illustrated in the second row in the block 410 of the flow diagram of FIG. 4.

The significance state of bits in the previous column t2 of the current bit-plane may be examined, i.e. the values of the significance propagation context matrix σ^{SPP}ₜ₂[i−1], σ^{SPP}ₜ₂[i] and σ^{SPP}ₜ₂[i+1]. If the significance state is significant (i.e. σ^{SPP}ₜ₂[i−1]≠0 or σ^{SPP}ₜ₂[i]≠0 or σ^{SPP}ₜ₂[i+1]≠0), significance propagation pass masks may be used 412 in encoding the context and decision pairs for this magnitude bit. This condition is illustrated in the third row in the block 410 of the flow diagram of FIG. 4.

When the current bit is the first bit in the stripe (i.e. i=0), the previous row refers outside of the current stripe row, i.e. i−1<0. Hence, in accordance with an embodiment, the significance state value of “insignificant” (0) is used for such bit positions. Correspondingly, when the current bit is the last bit in the stripe (i.e. i=3), the next row refers outside of the current stripe row, i.e. i+1>3. Hence, in accordance with an embodiment, the significance state value of “insignificant” (0) is used for such bit positions.

The significance state of the bit in the same column but in the previous row of the current bit-plane may also be examined, i.e. the value of the significance propagation pass matrix σ^{SPP}ₜ₁[i−1]. If the significance state is significant (i.e. σ^{SPP}ₜ₁[i−1]≠0), significance propagation pass masks may be used 412 in encoding the context and decision pairs for this magnitude bit. This condition is illustrated in the fourth row in the block 410 of the flow diagram of FIG. 4.

If none of the above mentioned examinations indicate that the significance state is significant, the process may continue to block 414 and use clean up masks in encoding the context and decision pairs for this magnitude bit.

If either of SPP or CU mask was used and the current magnitude bit is one, current magnitude bit will become significant and therefore sign coding context-decision pair CXS-S may also be given. This pair (728, 730) may share the ID (722) of the primary CX-D pair (724,726).

It should be noted here that the above mentioned four examinations may be performed in another order than described. Further, it is not necessary to perform all these four examinations if the significance state of some of the examined bits is found significant.

In other words, the examinations in block 410 may be interrupted when the first significant state has been found.

After performing the parallel context modelling with significance propagation pass mask 412, the clean up mask 414 or the magnitude refinement mask 408, the value of the parameter i may be examined 416 to determine whether all the samples of the current stripe has been examined. If not so (i<3), the parameter i is incremented by one 418 to take the next sample in the stripe under examination and the process is repeated from the block 404. If the samples of the stripe has been examined (i=3), it is further examined 420 whether the stripe was the last strip of the stripe row. If so, the next stripe may be examined, if any. Otherwise, the next stripe row may be examined by setting 422 the parameters to correspond with the new stripe: t0=new column (i.e. the next stripe of the new stripe to be examined), t1=t0 (the new stripe to be examined) and t2=t1 (the stripe just examined, which now becomes the previous stripe to the new stripe).

It should be noted that the functions 440 may be done in parallel, i.e. there is no actual advancement of i, but this is for illustration purposes only. The i may have value 0, 1, 2, and 3 simultaneously, therefore also outputting all the context fields (FIG. 7b) of all the context words 710 simultaneously.

Then, after processing of the current bit-plane the previous context matrix σ1 becomes the second-most previous context stripe 62 i.e. the second-most previous context stripe 62 gets the values of the previous context matrix σ1. Also the final context matrix σ becomes the previous context matrix σ1 i.e. the previous context matrix σ1 gets the values of the final context matrix σ. These can be done e.g. by changing the order of buffers which are used to store the values of the matrices. Hence, no actual copying of values may be needed.

The process explained above may be repeated until all stripe rows of the code-block on the current bit-plane have been examined.

The process explained above may be repeated until all code-blocks of the current tile have been examined.

The process explained above may be repeated until all the tiles of the current image have been examined.

In the following, the use of significance propagation pass mask 412, the clean up pass mask 414, and the magnitude refinement pass mask 408 are described in more detail with reference to FIGS. 6a to 6c.

The significance propagation pass mask 412 structure illustrated in FIG. 6a may be used to determine the context and decision pair for the current magnitude bit that may be given ID 722 of SPP. This mask may be called e.g. as a past significant propagation mask 602, and a future significant state mask 604. As is shown in FIG. 6a, some of the neighboring bits to be examined may be selected from the previous bit-plane and some of the neighboring bits to be examined may be selected from the σ^{SPP} of the same bit-plane of the current bit. The bits of the previous bit-plane are the three bits (i−1, i. i+1) on the next column (t0) and one bit on the same column (t1) but on the next row (i+1). Correspondingly, the bits of the same bit-plane of the σ^{SPP} are the three bits (i−1, i. i+1) on the previous column (t2) and one bit on the same column (t1) but on the previous row (i−1). The context to be selected may depend on one or more of the significant state values of these bits. The context may also depend on the subband to which the current code-block belongs. In accordance with an embodiment, if the significant state value of a neighboring bit σ^{SPP}ₜ₂[i] or σ1ₜ₀[i] (i.e. in the horizontal direction but in different bit-planes) is significant or if the significant state value of a neighboring bit σ1ₜ₁[i+1] or σ^{SPP}ₜ₁[i−1] (i.e. in the vertical direction but in different bit-planes) is significant, a first context may be selected irrespective of the significance status of the examined bits in a diagonal direction (i.e. σ^{SPP}ₜ₂[i−1], σ^{SPP}ₜ₂[i+1], σ1ₜ₀[i−1], σₜ₀[i+1]). A second context may be selected, if none of the examined bits in the horizontal or vertical direction has significant status, but any of the examined bits in a diagonal direction (i.e. σ^{SPP}ₜ₂[i−1 ], σ^{SPP}ₜ₂[i+1], σ1ₜ₀[i−1], σ1ₜ₀[i+1]) is significant. It should be noted here that these context selection models are just non-limiting examples and other models may also be used in the selection of the context.

The clean up mask 414 structure, illustrated in FIG. 6b, may be used to determine the context and decision pair for the current magnitude bit that may be given ID 722 of CU. These masks may be called e.g. as a future significant propagation mask 606, and a past significant state mask 608. Similar procedures for the context selection may be applied than in the significance propagation pass, but the examined bits are selected from context matrices in a different way. The examined values may be as follows: final significance state values of three bits (i−1, i, i+1) of the current bit-plane on the previous column (t2) and one bit on the same column (t1) but on the previous row (i−1). Correspondingly, the significance state values of three bits (i−1, i. i+1) of the next column (t0) and one bit on the same column (t1) but on the next row (i+1) are examined from the significance propagation pass context matrix σ^{SPP}.

The magnitude refinement pass mask 408 structure, illustrated in FIG. 6c, may be used to determine the context and decision pair for the current magnitude bit that may be given ID 722 of MRP. These masks and/or significance state value from the previous 61 and second-most previous context stripe 62, namely the significance state value of the same magnitude bit location (t1, i) than the current bit. Those masks may be called e.g. as the past significant propagation mask 602, and the future significant propagation mask 606. If the significance state value σ2ₜ₁[i] is significant, further examination to determine the context may not be needed. If, however, the significance state value σ2ₜ₁[i]=0, it may then be deduced that the sample location to which the current bit belongs became significant on the bit-plane which is in the previous layer (because a σ1ₜ₁[i]=1 and σ2ₜ₁[i]=0). Hence, the context selection may utilize significance values of none, one or more of the neighboring bits from the significance propagation pass matrix σ^{SPP}, as can be seen from FIG. 6c.

As a non-limiting example of the processing method of FIG. 4 and in parallel single-pass context modeling, the following context matrix values might be used, referring to FIG. 7e. When i=0, the value up would be zero as indicated on (t1,0), regardless which context mask is used. The value on the right, indicated (t0,1) in FIG. 7e, is picked from the previous context matrix σ1 for the significance propagation pass context 412, and from the significance propagation pass matrix σ^{SPP} for both the clean up pass context 414 and for the magnitude refinement pass context 408. The current stripe is indicated with the hatched rectangle 740 in FIG. 7e. Also as a non-limiting example, significance in location (t2,3) would be diagonal bottom left for i=1, horizontal left for i=2 and diagonal up left for i=3, and it would be selected from the final context matrix σ for the clean up pass 414 and from the significance propagation pass matrix σ^{SPP} for both the significance propagation pass 412 and the magnitude refinement pass 408. Significance on (t1,2) would be the bottom value for i=0 and the up value for i=2 and unlike in the examples above, it's selection may also depend from the value i, not only which context is being assigned. For example in the significance propagation pass, when i=0 the (t1,2) would be from the previous context matrix σ1 and for i=2 from the significance propagation pass context matrix σ^{SPP}. When i=1 (t1,2) magnitude is used, not the context (after the decision in which context ID will be assigned).

Since the context selection may be implementation specific and does not affect to the selection of the passes 408, 412, 414, no further details are provided in this context.

The described embodiment may also comprise a run-length coding element 143, which may perform run-length coding for the magnitude bits of the stripe and give out the run-length context RL in FIG. 7c.

The output of the above described parallel single-pass context modeling element 142 may be a context label and decision pair for each bit of a stripe 710. A non-limiting example of the context output 710 for one stripe is depicted in FIG. 7c. The context output 710 may comprise a run-length context 712 (RL), a first context 714 (CX0) indicating the context selected for the first magnitude bit of the stripe, a second context 716 (CX1) indicating the context selected for the second magnitude bit of the stripe, a third context 718 (CX2) indicating the context selected for the third magnitude bit of the stripe, and a fourth context 720 (CX3) indicating the context selected for the fourth magnitude bit of the stripe.

An example of a content of one bit in the context output 710 is depicted in FIG. 7b. It comprises an identifier mask 722 (ID), a context mask 724 (CX), a decision mask 726 (D), a sign context mask 728 (SCX) and a sign mask 730 (S).

In accordance with an embodiment, the context output 710 may have e.g. two bits for the run-length, two bits for the uniform field, and four 11-bit context words for each bit of the stripe, as is illustrated in FIG. 7c. However, this is only an example, but also other kinds of context outputs may be used.

The context outputs 710 may be input to the arithmetic encoder 144 which encodes the context outputs and provides the encoding result to the tier-2 coding block 150. The rate control block 160 may perform rate control to adjust the amount of data to be transmitted.

As was already mentioned above, the decoder 200 may perform decoding operations which may mainly correspond to inverse operations of the encoder 100. The encoded code stream may be received and provided to the tier-2 decoding block 210 to form reconstructed arithmetic code words. These code words may be decoded by the tier-1 decoding block 220. The resulting reconstructed quantized coefficient values may be dequantized by the dequantization block 230 to produce reconstructed dequantized coefficient values. These may be inverse transform by the inverse intracomponent transform block 240 and the inverse multicomponent transform block 250 to produce reconstructed pixel values of the encoded image.

In the above description the tier-1 encoding was performed on quantized coefficient values obtained from the discrete wavelet transform. However, similar encoding operations may also be performed to other kind of data in a rectangular form, such as to pixel values of the original image. However, omitting the discrete wavelet transform may cause less efficient compression of the image.

Further, in the above examples the significance state value for “significant” was 1 and the significance state value for “insignificant” was 0. However, these may also be defined otherwise, for example the other way round. Then, the significance state value for “significant” were 0 and the significance state value for “insignificant” were 1.

The architecture of the apparatus 100 and/or 200 may be realized e.g. as a general purpose field programmable gate array (FPGA), application specific instruction set processor (ASIP), an application specific integrated circuit (ASIC) implementation or other kind of integrated circuit implementation, or any combination of these, which performs the procedures described above.

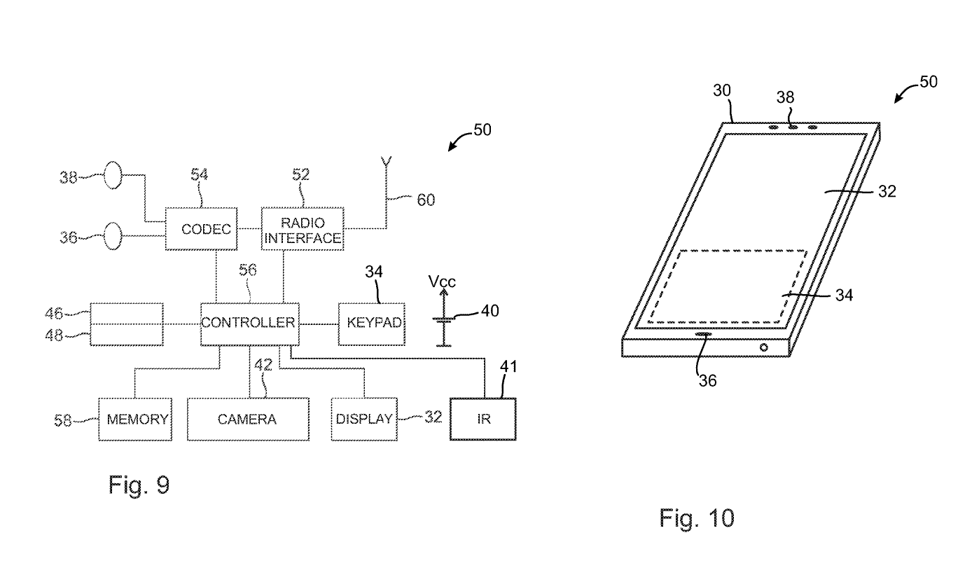

The following describes in further detail suitable apparatus and possible mechanisms for implementing the embodiments of the invention. In this regard reference is first made to FIG. 9 which shows a schematic block diagram of an exemplary apparatus or electronic device 50 depicted in FIG. 10, which may incorporate a transmitter according to an embodiment of the invention.

The electronic device 50 may for example be a mobile terminal or user equipment of a wireless communication system. However, it would be appreciated that embodiments of the invention may be implemented within any electronic device or apparatus which may require transmission of radio frequency signals.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The term battery discussed in connection with the embodiments may also be one of these mobile energy devices. Further, the apparatus 50 may comprise a combination of different kinds of energy devices, for example a rechargeable battery and a solar cell. The apparatus may further comprise an infrared port 41 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC reader and UICC for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 60 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera 42 capable of recording or detecting imaging.

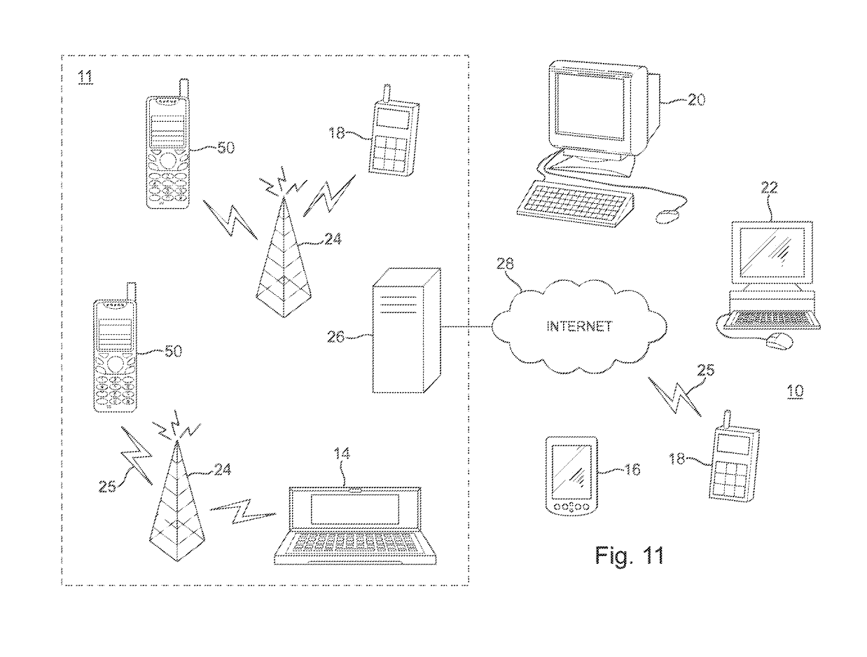

With respect to FIG. 11, an example of a system within which embodiments of the present invention can be utilized is shown. The system 10 comprises multiple communication devices which can communicate through one or more networks. The system 10 may comprise any combination of wired and/or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

For example, the system shown in FIG. 11 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22, a tablet computer. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system

(UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, Long Term Evolution wireless communication technique (LTE) and any similar wireless communication technology. A communications device involved in implementing various embodiments of the present invention may communicate using various media including, but not limited to, radio, infrared, laser, cable connections, and any suitable connection. In the following some example implementations of apparatuses utilizing the present invention will be described in more detail.

Although the above examples describe embodiments of the invention operating within a wireless communication device, it would be appreciated that the invention as described above may be implemented as a part of any apparatus comprising a circuitry in which radio frequency signals are transmitted and received. Thus, for example, embodiments of the invention may be implemented in a mobile phone, in a base station, in a computer such as a desktop computer or a tablet computer comprising radio frequency communication means (e.g. wireless local area network, cellular radio, etc.).

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1-23. (canceled)

24. A method comprising:
obtaining a stripe comprising two or more magnitude bits of two or more coefficients, each of the two of more magnitude bits being from different coefficient of the two or more coefficients and belonging to the same bit-plane, said two or more coefficients representing an image or a part of the image;
obtaining a context matrix comprising a significance state of said two or more coefficients and a significance state of coefficients neighboring said two or more coefficients on a current bit-plane;
obtaining a previous layer context matrix comprising the significance state of said coefficients and the significance state of coefficients neighboring said two or more coefficients on a previous bit-plane which is one layer above the current bit-plane;
obtaining a context stripe of a bit-plane which is two layers above the current bit-plane comprising the significance state of said coefficients on a bit-plane which is two layers above the current bit-plane;
obtaining a significance propagation state context matrix comprising a significance propagation significance state of said two or more coefficients and a significance propagation significance state of coefficients neighboring the said two or more coefficients on the current bit-plane; and
using at least one of said context matrix, said previous layer context matrix, said significance propagation state context matrix and/or said context stripes to construct a context label for each said two or more magnitude bits in parallel by assigning a context label selected from a set of context labels.

25. The method according to claim 24 further comprising:
obtaining a sign context matrix comprising a sign of the said coefficients and a sign of coefficients neighboring the said two or more coefficients; and
using at least one of said context matrix, said previous layer context matrix, said significance propagation state context matrix, said sign context matrix and/or said context stripes to construct the context label for each said two or more magnitude bits in parallel by assigning a context label selected from the set of context labels.

26. The method according to claim 24, wherein the construction of the context label comprises:
using magnitude refinement masks, if a first condition is true; or
using significance propagation masks, if the first condition is not true and a second condition is true; or
using clean up masks, if the first condition and the second condition are not true.

27. The method according to claim 26 comprising:
determining whether the first condition is true by examining if the significance state of a coefficient in the previous layer context matrix is true; or
determining whether the second condition is true by examining if the significance state of a neighbour coefficient in the previous layer context matrix is true, or the significance propagation significance state of a neighbour coefficient in the significance propagation state context matrix is true.

28. The method according to claim 27, said determining whether the second condition is true comprising:
examining the significance state of one or more of the following neighbour coefficients in the previous layer context matrix:
in the same column in the previous row; and
in the next column; and
examining the significance state of one or more of the following neighbour coefficients in the significance propagation state context matrix:
in the same column in the next row; and
in a previous column.

29. The method according to claim 26, wherein:
the magnitude refinement masks comprise significance states from the significance propagation state context matrix of coefficients surrounding the coefficient, and a significance state of the coefficient in the previous layer context matrix;
the significance propagation masks comprise significance states from the significance propagation state context matrix of neighbour coefficients in the previous column and the neighbor coefficient in the same column in the previous row than the coefficient, and significance states from the previous significance state context matrix of neighbour coefficients in the next column and the neighbor coefficient in the same column in the next row than the coefficient, and the significance state of the coefficient in the previous layer context matrix;
the clean up masks comprise significance states from the significance propagation state context matrix of neighbour coefficients in the previous column and the neighbor coefficient in the same column in the previous row than the coefficient, and significance states from the significance propagation state context matrix of neighbour coefficients in the next column and the neighbor coefficient in the same column in the next row than the coefficient, and the significance state of the coefficient in the previous layer context matrix.

30. The method according to claim 26, comprising:
selecting the context label for a coefficient on the basis of one or more significance states indicated by the magnitude refinement masks, the significance propagation masks, or the clean up masks or on the basis of the value of the coefficient on the current bit-plane.

31. The method according to claim 24, wherein the coefficients are organized in rows and columns.

32. The method according to claim 24, constructing the context label further comprising:
including the selected context label into a context word; and
including each context word selected for the coefficients of the stripe into a code word.

33. The method according to claim 24, wherein elements of said context matrix, said previous layer context matrix, and said significance propagation state context matrix are related to locations of the coefficients and locations surrounding the coefficients of the matrix.

34. The method according to claim 24, wherein the stripe has four coefficients, and said context matrix, said previous layer context matrix, and said significance propagation state context matrix have 12 elements.

35. The method according to claim 24 further comprising:
performing run-length coding on the basis of the coefficients of the stripe on the current bit-plane; and
attaching information regarding the run-length coding with the selected context labels.

36. An apparatus comprising at least one processor; and at least one memory including computer program code; the at least one memory and the computer program code configured to, with the at least one processor, cause the apparatus at least to perform:
obtain a stripe comprising two or more magnitude bits of two or more coefficients, each of the two of more magnitude bits being from different coefficient of the two or more coefficients and belonging to the same bit-plane, said two or more coefficients representing an image or a part of the image;
obtain a context matrix comprising a significance state of said two or more coefficients and a significance state of coefficients neighboring said two or more coefficients on a current bit-plane;
obtain a previous layer context matrix comprising the significance state of said coefficients and the significance state of coefficients neighboring said two or more coefficients on a previous bit-plane which is one layer above the current bit-plane;
obtain a context stripe of a bit-plane which is two layers above the current bit-plane comprising the significance state of said coefficients on a bit-plane which is two layers above the current bit-plane;
obtain a significance propagation state context matrix comprising the significance propagation significance state of said two or more coefficients and a significance propagation significance state of coefficients neighboring said two or more coefficients on the current bit-plane; and
use at least one of said context matrix, said previous layer context matrix, said significance propagation state context matrix and/or said context stripes to construct a context label for each said two or more magnitude bits in parallel by assigning a context label selected from a set of context labels.

37. The apparatus according to claim 36, said at least one memory stored with computer program code thereon, which when executed by said at least one processor, causes the apparatus to:
obtain a sign context matrix comprising the sign of the said coefficients and the sign of coefficients neighboring the said two or more coefficients; and
use at least one of said context matrix, said previous layer context matrix, said significance propagation state context matrix, said sign context matrix and/or said context stripes to construct the context label for each said two or more magnitude bits in parallel by assigning a context label selected from the set of context labels.

38. The apparatus according to claim 36, said at least one memory stored with computer program code thereon, which when executed by said at least one processor, causes the apparatus to construct the context label by:
using magnitude refinement masks, if a first condition is true; or
using significance propagation masks, if the first condition is not true and a second condition is true; or
using clean up masks, if the first condition and the second condition are not true.

39. The apparatus according to claim 38, said at least one memory stored with computer program code thereon, which when executed by said at least one processor, causes the apparatus to:
determine whether the first condition is true by examining if the significance state of a coefficient in the previous layer context matrix is true; or
determine whether the second condition is true by examining if the significance state of a neighbour coefficient in the previous layer context matrix is true, or the significance propagation significance state of a neighbour coefficient in the significance propagation state context matrix is true.

40. The apparatus according to claim 39, said at least one memory stored with computer program code thereon, which when executed by said at least one processor, causes the apparatus to determine whether the second condition is true by:
examining the significance state of one or more of the following neighbour coefficients in the previous layer context matrix:
in the same column in the previous row; and
in the next column; and
examining the significance state of one or more of the following neighbour coefficients in the significance propagation state context matrix:
in the same column in the next row; and
in a previous column.

41. The apparatus according to claim 38, wherein:
the magnitude refinement masks comprise significance states from the significance propagation state context matrix of coefficients surrounding the coefficient, and a significance state of the coefficient in the previous layer context matrix;
the significance propagation masks comprise significance states from the significance propagation state context matrix of neighbour coefficients in the previous column and the neighbor coefficient in the same column in the previous row than the coefficient, and significance states from the previous significance state context matrix of neighbour coefficients in the next column and the neighbor coefficient in the same column in the next row than the coefficient, and the significance state of the coefficient in the previous layer context matrix;
the clean up masks comprise significance states from the significance propagation state context matrix of neighbour coefficients in the previous column and the neighbor coefficient in the same column in the previous row than the coefficient, and significance states from the significance propagation state context matrix of neighbour coefficients in the next column and the neighbor coefficient in the same column in the next row than the coefficient, and the significance state of the coefficient in the previous layer context matrix.

42. The apparatus according to claim 38, said at least one memory stored with computer program code thereon, which when executed by said at least one processor, causes the apparatus to:
select the context label for a coefficient on the basis of one or more significance states indicated by the magnitude refinement masks, the significance propagation masks, or the clean up masks or on the basis of the value of the coefficient on the current bit-plane.

43. The apparatus according to claim 36, said at least one memory stored with computer program code thereon, which when executed by said at least one processor, causes the apparatus to:
include the selected context label into a context word; and
include each context word selected for the coefficients of the stripe into a code word.

44. The apparatus according to claim 36, said at least one memory stored with computer program code thereon, which when executed by said at least one processor, causes the apparatus to:
perform run-length coding on the basis of the coefficients of the stripe on the current bit-plane; and
attach information regarding the run-length coding with the selected context labels.
